(19) United States
(12) Patent Application Publication
(10) Pub. No.: US 2026/0067586 A1
(43) Pub. Date: Mar. 5, 2026

(54) PEERING SENSORS AND METHODS

(71) Applicant: A Priori Robotics, Inc., Mont Vernon, NH (US)

(72) Inventor: Brandon D. Northcutt, Mont Vernon, NH (US)

(73) Assignee: A Priori Robotics, Inc., Mont Vernon, NH (US)

(21) Appl. No.: 19/312,818

(22) Filed: Aug. 28, 2025

Related U.S. Application Data
(60) Provisional application No. 63/691,041, filed on Sep. 5, 2024.

(51) Int. Cl. H04N 23/95; H04N 23/50; H04N 23/54

(52) U.S. Cl. CPC H04N 23/95; H04N 23/54; H04N 23/555

(57) ABSTRACT

In one embodiment, a peering sensor includes an image sensor. The peering sensor also includes an actuator coupled to the image sensor. The peering sensor further includes one or more processors operable to control the actuator to translate the image sensor across a travel length at a speed, control the image sensor to generate a plurality of images at a frame rate as the image sensor is translated across the travel length, and generate a depth image from the plurality of images.

### CROSS-REFERENCE TO RELATED APPLICATIONS

This application claims priority to U.S. Provisional Application 63/691,041 filed on Sep. 5, 2024 and entitled “Systems and Methods for Computing Depth from Camera Images Using Peering Motions.”

### BACKGROUND

A depth camera is a device that not only captures image data but also depth information of objects within the field of view of the depth camera. Some depth cameras contain a patterned infrared light projector separated by some distance from an infrared camera where the distance to objects is measured as apparent projected pattern shift. Another type of active light emitting depth camera uses bright wide-angle infrared light pulses and a specialized image detector able to calculate distance to objects in the scene by measuring the time light takes to return from reflecting off of objects in the scene.

Other depth cameras utilize two or more image sensors spaced apart by a distance. Depth of objects within the field of view is obtained by triangulation in a manner similar to human eyes.

However, infrared lasers and detectors, as well as additional image sensors, add weight, size and cost to the depth camera. The additional weight, size and cost may make such depth sensors incompatible with particular applications, such as miniature and/or low-cost devices.

Accordingly, alternative depth sensors having reduced weight, size and cost may be desired.

### BRIEF SUMMARY

In one embodiment, a peering sensor includes an image sensor. The peering sensor also includes an actuator coupled to the image sensor. The peering sensor further includes one or more processors operable to control the actuator to translate the image sensor across a travel length at a speed, control the image sensor to generate a plurality of images at a frame rate as the image sensor is translated across the travel length, and generate a depth image from the plurality of images.

In another embodiment, a method of generating a depth image includes translating an image sensor of a peering sensor across a travel length at a speed, capturing a plurality of images as the image sensor translates across the travel length, and generating a depth image from the plurality of images.

In yet another embodiment, an endoscope includes an endoscopic tube and a peering sensor positioned at an end of the endoscopic tube. The peering sensor includes a housing, and at least one light source and a window at the housing. The peering sensor also includes a micro-linear actuator disposed within the housing. The peering sensor further includes an image sensor within the housing, coupled to the micro-linear actuator, and having a field of view through the window. The peering sensor also includes one or more processors programmed to control the micro-linear actuator to translate the image sensor across a travel length at a speed, control the image sensor to generate a plurality of images at a frame rate as the image sensor is translated across the travel length, and generate a depth image from the plurality of images.

These and additional features provided by the embodiments described herein will be more fully understood in view of the following detailed description, in conjunction with the drawings.

### BRIEF DESCRIPTION OF THE SEVERAL VIEWS OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates an isometric view of an example peering sensor according to one or more embodiments described and illustrated herein.

FIG. 2 illustrates a front elevation view of the example peering sensor of FIG. 1 according to one or more embodiments described and illustrated herein.

FIG. 3 illustrates a top view of the example peering sensor of FIG. 1 according to one or more embodiments described and illustrated herein.

FIG. 4 illustrates an example peering triangulation diagram according to one or more embodiments described and illustrated herein.

FIG. 5 illustrates a graph illustrating captured images at a plurality of linear positions over a period of time according to one or more embodiments described and illustrated herein.

FIG. 6 illustrates components of an example peering sensor according to one or more embodiments described and illustrated herein.

FIG. 7 illustrates an isometric view of an example peering sensor according to one or more embodiments described and illustrated herein.

FIG. 8 illustrates a top view of the example peering sensor of FIG. 8 according to one or more embodiments described and illustrated herein.

FIG. 9 illustrates an example peering sensor according to one or more embodiments described and illustrated herein.

FIG. 10 illustrates an example endoscope according to one or more embodiments described and illustrated herein.

### DETAILED DESCRIPTION

Embodiments of the present disclosure are directed to peering sensors operable to generate depth images by motion parallax. Animals throughout the animal kingdom, such as deer, locusts, mice and others, often use head motion to estimate depth. Embodiments leverage motion parallax to provide depth sensors that utilize only one image sensor, rather than multiple image sensors used in current depth sensors. Elimination of one more image sensors significantly reduces the size of the depth sensor, which enables countless applications that were previously not available to present depth sensors, such as endoscopes.

More particularly, embodiments of the present disclosure include a single image sensor that is rapidly translated about travel length while also rapidly generating a plurality of sequential images at a fast frame rate. These images are then used to generate a depth image by use of a triangulation technique. Such peering sensors may be used in many applications, such as robotics, medical devices, vehicles, aircraft, space and defense, and surveillance, as non-limiting examples.

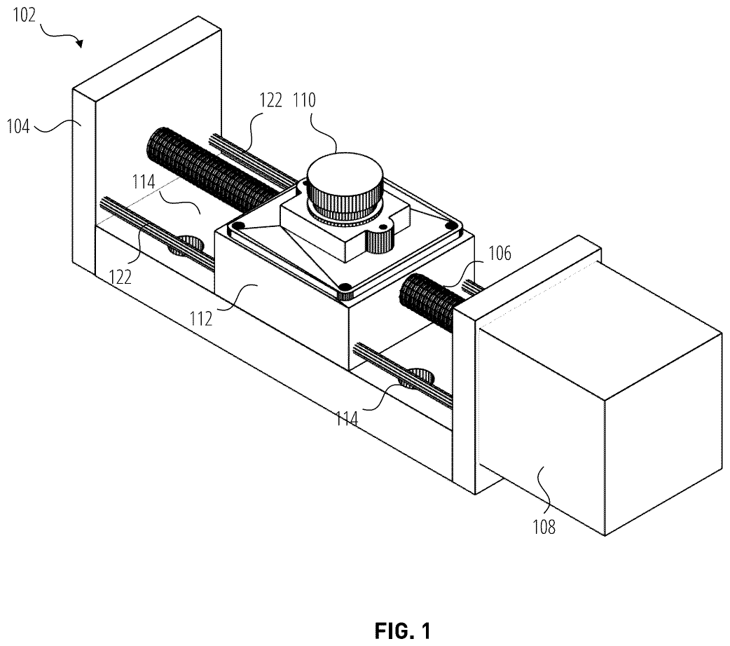

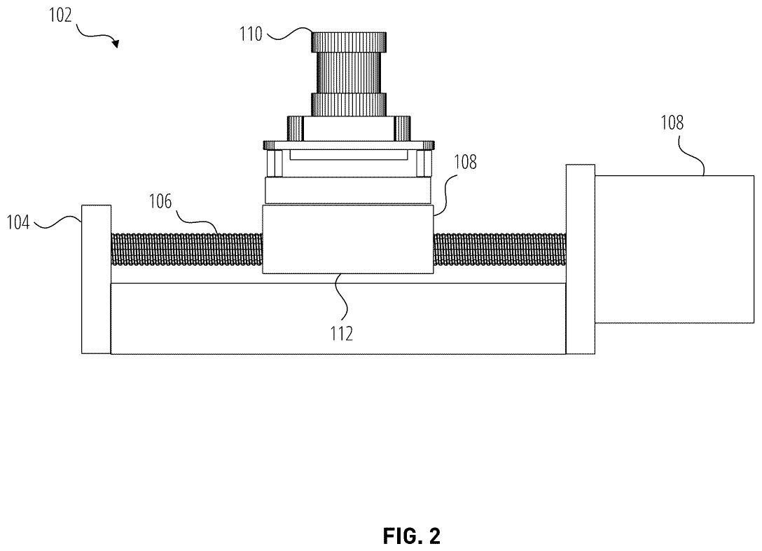

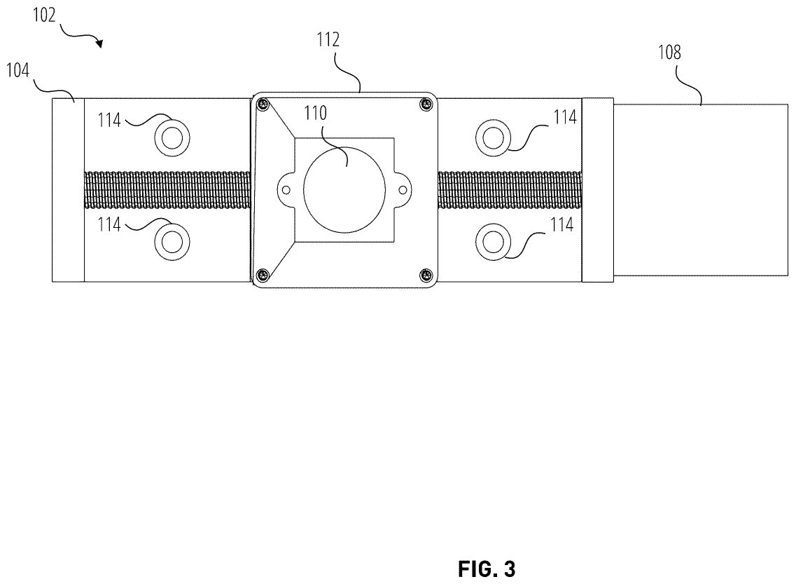

Referring now to FIGS. 1-3, an example peering sensor 102 is illustrated (also referred to herein as a depth sensor). FIG. 1 is an isometric view of the peering sensor 102, FIG. 2 is a front elevation view of the peering sensor 102, and FIG. 3 is a top view of the peering sensor 102. The example peering sensor 102 includes a frame 104 that is generally U-shaped. A lead screw 106 is disposed through walls of the frame 104 such that it is offset from a floor of the frame 104. A sensor base 112 is attached to the floor of the frame 104. One or more mounting holes 114 may be provided through the frame 104 for attaching the peering sensor 102 to another component, such as a mount, a robot component, vehicle component, or any other component in which the peering sensor 102 is utilized.

An image sensor 110 is coupled to a top surface of the sensor base 112. The image sensor is operable to generate a plurality of sequential images as a fast frame rate, such as a frame rate within the range of 0-250 Hz, including endpoints, with a minimum peering movement of 5 micrometers and a maximum peering distance of 50 millimeters. As non-limiting examples, the image sensor may be a monochromatic global shutter image sensor or an event camera.

The lead screw 106 is threadedly disposed through the sensor base 112. An end of the lead screw 106 is coupled to a motor 108. Rotation of the motor 108 causes rotation of the lead screw 106, which further causes linear translation of the sensor base 112 and the image sensor 110. In some embodiments, one or more guide rails 122 pass through the sensor base 112 and are coupled to walls of the frame. The one or more guide rails 122 increase stability of the sensor base 112 as it translates.

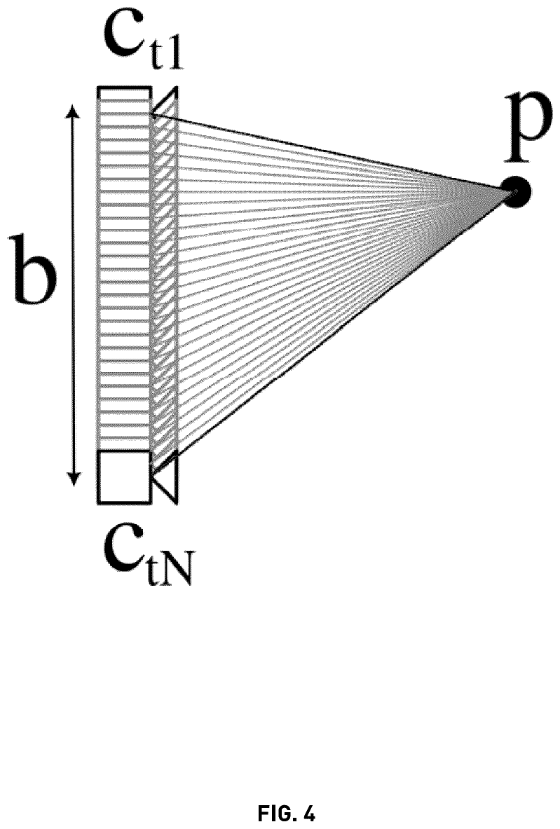

Thus, the peering sensor 102 produces precise pure translational motion of the image sensor 110 along a single degree of freedom orthogonal to the view direction of the image sensor 110. A diagram of the peering motion provided by the peering sensor 102 is shown in FIG. 4. A visual peering motion takes advantage of the phenomenon of motion parallax where the apparent visual motion produced by peering is inversely proportional to the distance. In FIG. 4, Cu represents the position of the image sensor 110 at time t1 with a field of view of feature point p. Cin represents the position of the image sensor 110 at time tN after traveling baseline b travel length with a field of view of feature point p. The image sensor 110 can be translated back-and-forth along the travel length with the baseline b being varied to provide a plurality of baselines to best calculate a triangulation distance to feature point p.

Actively moving the image sensor 110 to produce a peering motion has the effect of causing motion parallax in the scene which can be measured on the image sensor 110 via an algorithm that measures displacement of image patterns, such as visual feature tracking, motion estimation, optic flow, and others.

The process of moving the image sensor 110 and measuring the effect that the motion has on the image that is produced differentiates embodiments of the present disclosure from prior monocular and multi-camera methods, which must either jointly solve for unknown camera motions or suffer from fixed multi-view baseline errors. A very narrow baseline between adjacent images while peering ensures high quality image feature tracking with very low computational cost.

As a non-limiting example, the sensor base 112 and the image sensor 110 have a maximum travel of about 50 millimeters and a minimum travel of 5 micrometers. This configuration allows the image sensor 110 to be positioned at approximately 10,000 locations along a line where images can be separated by as little as 5 micrometers or as much as 5 centimeters.

Narrow baselines have the best feature matching performance but have high error for triangulation distance, while wide baselines have low error distance triangulations but poor feature matching performance. Embodiments of the present disclosure provide the best of both worlds in robust feature matching of extremely narrow baseline and low error distance triangulations with wider baseline feature tracks accumulated over time.

As stated above, a peering depth estimation motion involves taking a sequence of images separated by small precise camera displacements and the distance can be computed via triangulation proportional to the observed motion parallax the peering produced. The distance of accurate depth estimation is proportional to the length of the peering motion. Short peering motions will provide accurate depth to objects near to the device and longer peering motions are needed to estimate depth to distant objects.

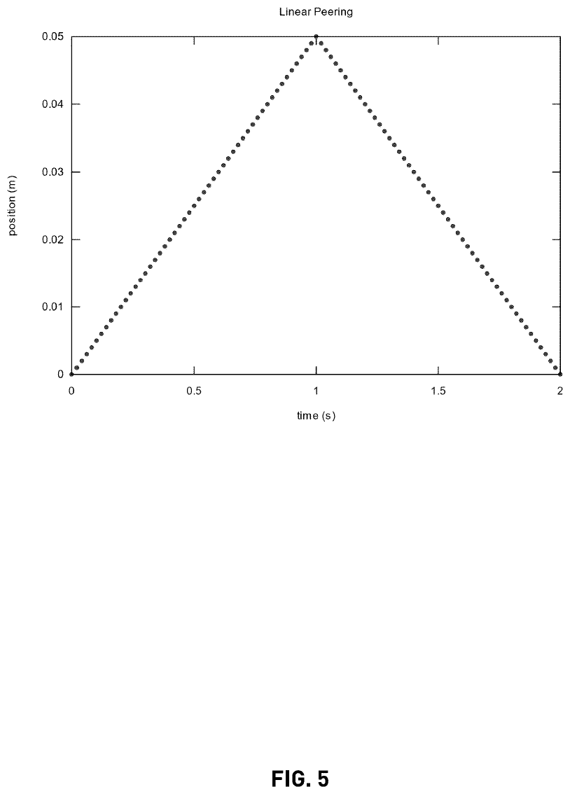

The motion profile of the peering motion can be dynamically adapted in real-time based upon the task and dynamics of the scene. An example motion profile taking advantage of the full range of motion is shown in FIG. 5, where the image sensor 110 takes fifty images, and the image sensor 110 is moved by 1 millimeter between each image acquisition. In FIG. 5, each captured image is represented by a circle. The x-axis is time and the y-axis is the linear position of the image sensor 110 along the travel length. The motion is repeated in reverse to return the camera to the starting position. Thus, images are captured while the image sensor 110 is moved in both directions, back-and-forth. This motion profile can be repeated continuously for a cyclical peering motion that enables the peering sensor 102 to produce continuous depth estimation. The speed at which the camera is moved and the frame rate at which the images are taken can be adapted to fit the range estimation task at hand. For example, very high frame rates and rapid motions for dynamic scenes or very long exposures and larger translation steps for dimly lit distant scenes. Thus, the frame rate and/or the translation speed may be dynamically adjusted depending on the needs of the application. It is also possible to adapt the image sensor motion and image acquisition to match the scene in a real-time closed loop fashion. It is further noted that, while a linear motion profile has the advantage of simplicity, other motion profiles, such as sinusoidal or aperiodic, can be utilized.

The peering sensor 102 may be a self-contained module with all the mechanisms, processors, and memory to perform peering image sensor motions and depth computation. The components of the peering sensor 102 shown in FIG. 1 may be disposed within a housing (not shown) for example.

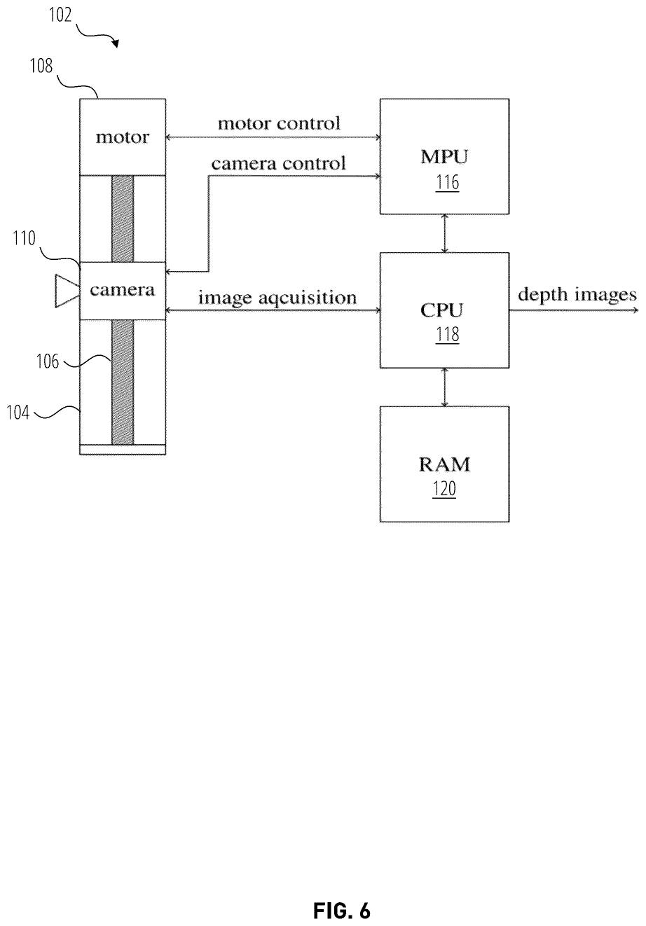

FIG. 6 illustrates additional example components of the peering sensor 102 illustrated in FIG. 1. The example peering sensor 102 of FIG. 6 further includes a micro-processing unit 116, a central processing unit 118 and a memory unit 120. The micro-processing unit 116 and the central processing unit 118 are referred to collectively as “processors.” The micro-processing unit 116 may be a real-time processor that is used to produce precisely timed signals for motor control and camera control (i.e., image sensor control). In other words, the micro-processing unit 116 is responsible for the frame rate of the image sensor 110 and the movement of the motor 108 to control the movement and position of the image sensor 110. The central processing unit 118 receives the image data from the image sensor 110 (e.g., camera), processes the depth information (e.g., depth images), and stores the depth images and captured images within the memory unit 120, which may be non-transitory memory component, such as random-access memory. The central processing unit 118 may also transmit the depth images to one or more remote computing components, such as processors of a robot, a vehicle, or other components.

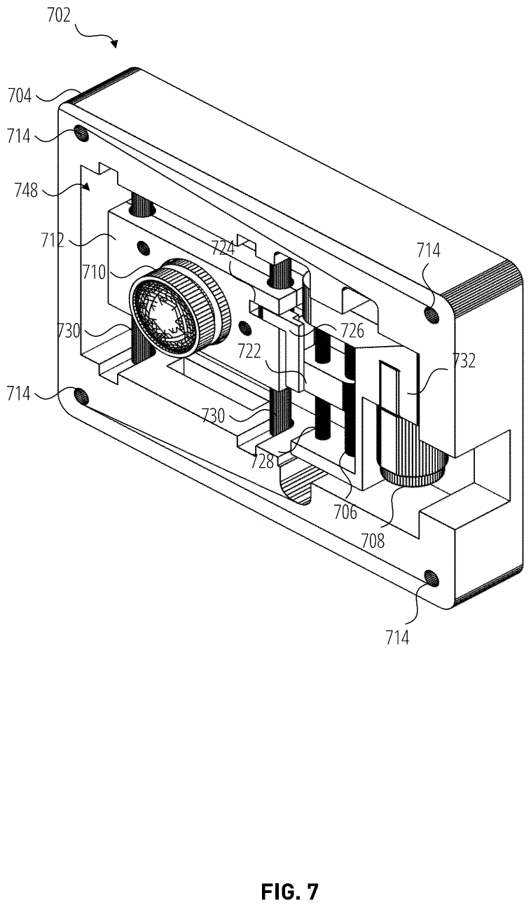

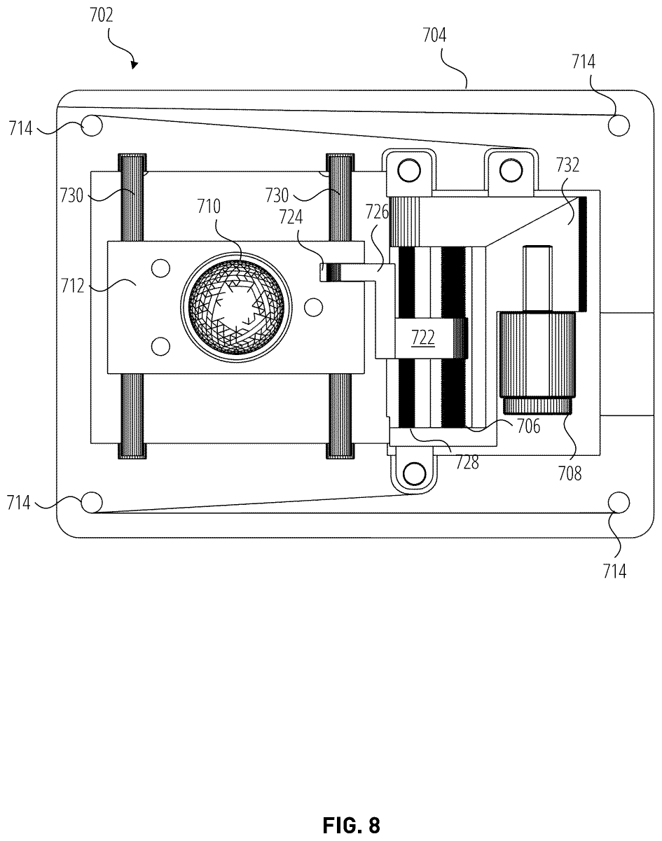

FIG. 7 and FIG. 8 illustrate another example peering sensor 702 having a shorter maximum travel length as compared with the example peering sensor 102 depicted in FIGS. 1-3. Thus, peering sensor 702 is more compact than peering sensor 102. Peering sensor 702 may be utilized in smaller applications, for example.

The peering sensor 702 includes a frame 704 having a recess 748. Mounting holes 714 for mounting the peering sensor 702 to another component may be provided. Two guide rails 730 are positioned across the recess 748. The two guide rails 730 are disposed through holes of a sensor base 712 such that the sensor base 712 may linearly translate along the two guide rails 730. An image sensor 710 is coupled to the sensor base 712 such that the image sensor 710 has a viewing direction that is orthogonal to the two guide rails 730.

The peering sensor 702 further includes a motor 708, which may also be disposed within the recess 748. A lead screw 706 is also disposed across the recess. The lead screw 706 is mechanically coupled to the motor 708, such as by one or more gears (not shown) so that rotation of the motor 108 causes rotation of the lead screw 706. An end 726 of a link arm 722 is coupled to the sensor base 712. In the illustrated embodiment, the end 726 of the link arm 722 is positioned within a notch 724 of the sensor base 712. However, the end 726 of the link arm 722 may be coupled to the sensor base 712 by other means. In some embodiments, one of the guide rails 730 passes through the end 726 of the link arm 722.

The lead screw 706 passes through the other end of the link arm 722. In the illustrated embodiment, another guide rail 728 is disposed within the recess 748 and passes through the link arm 722. Rotation of the motor 708, which may be a stepper motor, for example, causes the sensor base 712 base to linearly translate along the guide rail 728. In this manner, the image sensor 710 can linearly translate back-and-forth along a travel length to provide a baseline b (FIG. 4). As a non-limiting example, the baseline b may be within the range of 5 micrometers and 5 millimeters.

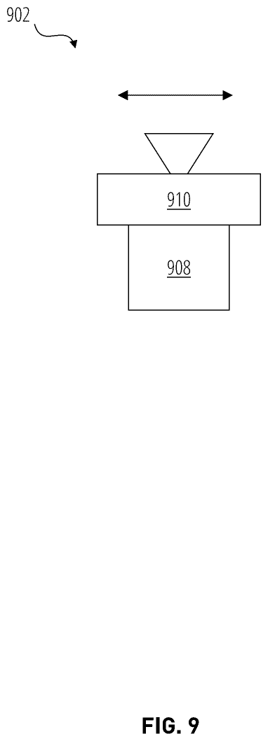

Referring now to FIG. 9, another example a peering sensor 902 having a very small travel length is illustrated. As a non-limiting example, the maximum travel length of the peering sensor 902 may be 1 millimeter, which enables it to be provided in very small applications.

The example peering sensor 902 includes an image sensor 910 coupled to a micro-linear actuator 908. The micro-linear actuator 908 may be a piezoelectric actuator that is operable to oscillate with the application of a voltage signal. Other example micro-linear actuators 908 include a voice coil, or other electromagnetic actuator. The actuation of the micro-linear actuator 908 causes the image sensor 910 to translate within the housing. The translation speed and distance can be adjusted based on the voltage signal that is provided to the micro-linear actuator 908.

One of the unique advantages of the embodiments of the present disclosure is the capability to estimate depth at very near distances to the camera sensor proportional to the minimum step size of the actuator chosen. The endoscopic use case with piezoelectric actuation can have sub-nanometer peering resolution giving a minimum distance measured in nanometers.

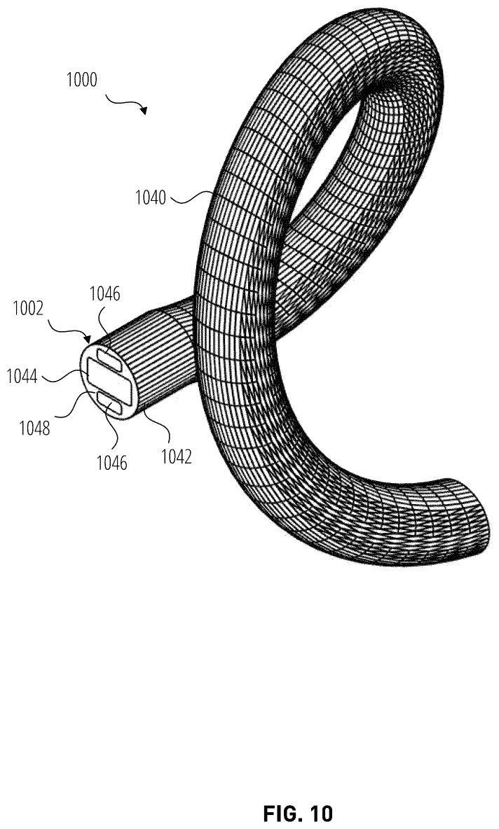

The compact nature of the peering sensor 902 allows it to be employed in small components, such as medical devices. FIG. 10 illustrates an example endoscope 1000 comprising a flexible tube 1040 having a peering sensor 1002 at its end. The tube 1040 may be configured as any known or yet-to-be-developed endoscopic tube. The peering sensor 1002 includes a housing 1042 that is coupled to the end of the endoscopic tube 1040. The housing 1042 contains an image sensor and an actuator, such as the image sensor 910 and the piezoelectric actuator 908 depicted in FIG. 9. The housing 1042 has an end face 1048 with a transparent window 1044 through which the image sensor 910 has a field of view. The end face 1048 further includes at least one light source 1046 operable to emit light and illuminate interior portions of the human body during operation. For example, the at least one light source 1046 may be configured as two light emitting diodes (LEDs). Light emitted by the at least one light source 1046 reflects off of objects and passes through the window 1044. The image sensor 910, which is oscillating back and forth by way of the piezoelectric actuator 908, receives the light and captures a plurality of sequential images. One or more processors use triangulation to generate continuous depth images that are transmitted to a display device, either wirelessly or through a wired connection. The one or more processors may be included within the housing 1042, or be separate from the endoscope 1000.

In yet another embodiment for biometric applications, an image sensor is positioned behind a transparent window within a housing configured for fingerprint or eye analysis. The device housing may contain one or more infrared illumination devices. A linear actuator is attached between the housing and the image sensor in order to translate the image sensor along guide rods in a pure translational motion orthogonal to the direction of view. The biometric peering sensor has one or more processors programmed to control camera position and image acquisitions. A plurality of images are captured from a plurality of camera positions and used to create 3D reconstructions of fingerprints, retinae, or irises for use in biometric authentication or eye health analysis.

In yet another embodiment of the peering depth camera for automotive applications, an image sensor is positioned within a housing located in either the front or rear aspect of an automobile. A linear actuator is attached between the housing and the image sensor in order to translate the image sensor along guide rods in a pure translational motion orthogonal to the direction of view. The peering sensor has one or more processors programmed to control camera position and image acquisitions. A plurality of images are captured from a plurality of camera positions and used to create 3D reconstructions of roads, vehicles, buildings, obstacles, pedestrians and other objects relevant to the driving task to inform advanced driver-assistance systems or autonomous driving tasks.

It should now be understood that embodiments of the present disclosure enable a compact depth sensor that utilizes a peering motion to estimate depth. Motion parallax allows for the elimination of an image sensor such that only one image sensor is needed. The image sensor is moved back-and-forth while sequential images are rapidly captured. A triangulation method is used to produce a depth image from the plurality of sequential images. The compact depth sensors described herein may be utilized in many different applications, such as robotics, vehicles, space and defense, medical devices and digital content creation.

In a first aspect, a peering sensor includes an image sensor. The peering sensor also includes an actuator coupled to the image sensor. The peering sensor further includes one or more processors operable to control the actuator to translate the image sensor across a travel length at a speed, control the image sensor to generate a plurality of images at a frame rate as the image sensor is translated across the travel length, and generate a depth image from the plurality of images.

A second aspect according to the first aspect, further comprising a sensor base coupled to the image sensor, and a lead screw coupled to the sensor base and the actuator, wherein the actuator comprises a stepper motor operable to translate the sensor base and the image sensor back and forth along the travel length defined by the lead screw.

A third aspect according to the first aspect, further comprising a sensor base coupled to the image sensor, a lead screw coupled to the actuator, and a link arm coupled to the lead screw and the sensor base, wherein the actuator comprises a stepper motor operable to translate the link arm back and forth along the lead screw such that the sensor base and image sensor translate back and forth along the travel length.

A fourth aspect according to the first aspect, wherein the actuator comprises a piezoelectric actuator operable to translate the image sensor along the travel length.

A fifth aspect according to any one of the first through fourth aspects, wherein the one or more processors are operable to dynamically adjust one or more of the speed of the image sensor and the frame rate of the image sensor to dynamically adjust a depth estimation distance of the peering sensor.

A sixth aspect according to any one of the first through fifth aspects, wherein the travel length is within a range of 5 micrometers to 50 millimeters, including endpoints.

A seventh aspect according to any one of the first through sixth aspects, wherein a frame rate is within a range of 0 Hz to 250 Hz.

An eighth aspect according to any one of the first through seventh aspects, wherein the depth image is generated by triangulation.

A ninth aspect according to any one of the first and fourth through eighth aspects, further comprising an endoscopic tube coupled to the actuator.

In a tenth aspect, a method of generating a depth image includes translating an image sensor of a peering sensor across a travel length at a speed, capturing a plurality of images as the image sensor translates across the travel length, and generating a depth image from the plurality of images.

An eleventh aspect according to the tenth aspect, further comprising translating an image sensor of a peering sensor across a travel length at a speed, capturing a plurality of images as the image sensor translates across the travel length, and generating a depth image from the plurality of images.

A twelfth aspect according to the tenth aspect or the eleventh aspect, wherein the peering sensor further comprises an actuator operable to translate the image sensor across the travel length.

A thirteenth aspect according to any one of the tenth through twelfth aspects, wherein the peering sensor further comprises a sensor base coupled to the image sensor, and a lead screw coupled to the sensor base and the actuator, wherein the actuator comprises a stepper motor operable to translate the sensor base and the image sensor back and forth along the travel length defined by the lead screw.

A fourteenth aspect according to any one of the tenth through twelfth aspects, wherein the peering sensor further comprises a sensor base coupled to the image sensor, a lead screw coupled to the actuator, and a link arm coupled to the lead screw and the sensor base, wherein the actuator comprises a stepper motor operable to translate the link arm back and forth along the lead screw such that the sensor base and image sensor translate back and forth along the travel length.

A fifteenth aspect according to any one of the tenth through twelfth aspects, wherein the actuator comprises a piezoelectric actuator operable to translate the image sensor along the travel length.

A sixteenth aspect according to any one of the tenth through fifteenth aspects, further comprising dynamically adjusting one or more of the speed of the image sensor and the frame rate of the image sensor to dynamically adjust a depth estimation distance of the peering sensor.

A seventeenth aspect according to any one of the tenth through sixteenth aspects, wherein the travel length is within a range of 5 micrometers to 50 micrometers, including endpoints.

An eighteenth aspect according to any one of the tenth through seventeenth aspects, wherein a frame rate is within a range of 0 to 250 Hz.

A nineteenth aspect according to any one of the tenth through eighteenth aspects, wherein the depth image is generated by triangulation.

In a twentieth aspect, an endoscopic scope includes an endoscopic tube and a peering sensor positioned at an end of the endoscopic tube. The peering sensor includes a housing, and at least one light source and a window at the housing. The peering sensor also includes a piezoelectric actuator disposed within the housing. The peering sensor further includes an image sensor within the housing, coupled to the piezoelectric actuator, and having a field of view through the window. The peering sensor also includes one or more processors programmed to control the piezoelectric actuator to translate the image sensor across a travel length at a speed, control the image sensor to generate a plurality of images at a frame rate as the image sensor is translated across the travel length, and generate a depth image from the plurality of images.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A peering sensor comprising:
an image sensor;
an actuator coupled to the image sensor;
one or more processors operable to:
control the actuator to translate the image sensor across a travel length at a speed;
control the image sensor to generate a plurality of images at a frame rate as the image sensor is translated across the travel length; and
generate a depth image from the plurality of images.

2. The peering sensor of claim 1, further comprising:
a sensor base coupled to the image sensor; and
a lead screw coupled to the sensor base and the actuator, wherein the actuator comprises a stepper motor operable to translate the sensor base and the image sensor back and forth along the travel length defined by the lead screw.

3. The peering sensor of claim 1, further comprising:
a sensor base coupled to the image sensor;
a lead screw coupled to the actuator; and
a link arm coupled to the lead screw and the sensor base, wherein the actuator comprises a stepper motor operable to translate the link arm back and forth along the lead screw such that the sensor base and the image sensor translate back and forth along the travel length.

4. The peering sensor of claim 1, wherein the actuator comprises a piezoelectric actuator operable to translate the image sensor along the travel length.

5. The peering sensor of claim 1, wherein the one or more processors are operable to dynamically adjust one or more of the speed of the image sensor and the frame rate of the image sensor to dynamically adjust a depth estimation distance of the peering sensor.

6. The peering sensor of claim 1, wherein the travel length is within a range of 5 micrometers to 50 millimeters.

7. The peering sensor of claim 1, wherein the frame rate is within a range of 0 to 250 Hz.

8. The peering sensor of claim 1, wherein the depth image is generated by triangulation.

9. The peering sensor of claim 1, further comprising an endoscopic tube coupled to the actuator.

10. A method of generating a depth image, the method comprising:
translating an image sensor of a peering sensor across a travel length at a speed;
capturing a plurality of images as the image sensor translates across the travel length; and
generating the depth image from the plurality of images.

11. The method of claim 10, wherein the depth image is generated by triangulation.

12. The method of claim 10, wherein the peering sensor further comprises an actuator operable to translate the image sensor across the travel length.

13. The method of claim 12, wherein the peering sensor further comprises:
a sensor base coupled to the image sensor; and
a lead screw coupled to the sensor base and the actuator, wherein the actuator comprises a stepper motor operable to translate the sensor base and the image sensor back and forth along the travel length defined by the lead screw.

14. The method of claim 12, wherein the peering sensor further comprises:
a sensor base coupled to the image sensor;
a lead screw coupled to the actuator; and
a link arm coupled to the lead screw and the sensor base, wherein the actuator comprises a stepper motor operable to translate the link arm back and forth along the lead screw such that the sensor base and the image sensor translate back and forth along the travel length.

15. The method of claim 12, wherein the actuator comprises a piezoelectric actuator operable to translate the image sensor along the travel length.

16. The method of claim 10, further comprising dynamically adjusting one or more of the speed of the image sensor and a frame rate of the image sensor to dynamically adjust a depth estimation distance of the peering sensor.

17. The method of claim 10, wherein the travel length is within a range of 5 micrometers to 50 millimeters.

18. The method of claim 10, wherein a frame rate is within a range of 0 to 250 Hz.

19. The method of claim 10, wherein the depth image is generated by triangulation.

20. An endoscope comprising:
an endoscopic tube;
a peering sensor positioned at an end of the endoscopic tube, the peering sensor comprising:
a housing;
at least one light source at the housing;
a window at the housing;
a micro-linear actuator disposed within the housing;
an image sensor within the housing, coupled to the micro-linear actuator, and having a field of view through the window;
one or more processors programmed to:
control the micro-linear actuator to translate the image sensor across a travel length at a speed;
control the image sensor to generate a plurality of images at a frame rate as the image sensor is translated across the travel length; and
generate a depth image from the plurality of images.
